(19) United States
(12) Patent Application Publication
(10) Pub. No.: US 2026/0086921 A1
(43) Pub. Date: Mar. 26, 2026

(54) METHOD AND APPARATUS FOR IMPROVING SYSTEM OVERHEAD FOR API TRACE CAPTURE

(71) Applicant: Samsung Electronics Co., Ltd., Gyeonggi-do (KR)

(72) Inventors: Chris Robert STEINBERG, II, Austin, TX (US); Gabriel DAGANI, Austin, TX (US); Warren PAUL, Austin, TX (US); Ronnie KING, Round Rock, TX (US)

(21) Appl. No.: 19/037,059

(22) Filed: Jan. 24, 2025

Related U.S. Application Data
(60) Provisional application No. 63/697,041, filed on Sep. 20, 2024.

(51) Int. Cl. G06F 11/362

(52) U.S. Cl. CPC G06F 11/3636; G06F 11/3644

(57) ABSTRACT

An apparatus, method, and storage medium are disclosed. The method includes the steps of generating, at an initial stage of an application session, an asset vault comprising a set of assets captured by an application programming interface (API) recording mechanism for use by an application; initiating a capture process within the application session; recording API commands in a capture file during the capture process, wherein the capture file includes a reference to the asset vault; and generating one or more images or frames of rendered content using the capture file.

### CROSS-REFERENCE TO RELATED APPLICATION

This application claims the priority benefit under 35 U.S.C. § 119(e) of U.S. Provisional Application No. 63/697,041, filed on Sep. 20, 2024, the entire contents of which are incorporated herein by reference.

### TECHNICAL FIELD

The disclosure generally relates to application programming interface (API) tracing and debugging tools for software applications that utilize accelerators such as graphics processing units (GPUs). More particularly, the subject matter disclosed herein relates to improvements in reducing system overhead during the capture of graphics API traces, specifically through optimizing the storage and reuse of asset data to improve efficiency and accuracy in trace capturing.

### SUMMARY

Software tools for capturing API traces, particularly for graphics applications using accelerators like GPUs, are commonly used to monitor and debug an application's command stream. These tools record an application's interactions with the GPU, allowing developers to replay the captured trace for debugging. Typically, this involves saving large sets of asset data, such as textures, shaders, and buffers, required to replicate the application state during playback. While capturing these assets alongside command streams enables accurate trace replay, it may increase memory and central processing unit (CPU) overhead, especially when capturing multiple traces of the same application session.

Some API trace capture tools store all asset data directly within each trace file, regardless of whether the assets are reused across multiple captures. This approach is convenient for trace replay, as all data needed to reproduce the application state is included in each capture file. However, this approach can lead to significant data redundancy, as the same assets are repeatedly saved with each capture. Attempts to reduce trace overhead in the past often focus on compression techniques or selective data capture, but these approaches still struggle with redundancy and may not efficiently handle multiple traces of the same workload.

One issue with the above approach is that it requires duplicating asset data across multiple captures, resulting in high memory usage, increased file sizes, and CPU overhead. This redundancy is particularly problematic when capturing repeated sessions of the same application, as the large, unchanging assets are saved each time, consuming unnecessary resources and slowing down the capture process. Additionally, capturing asset data at the start of each trace can cause significant delays, affecting the accuracy of profiling data for the initial frames of each capture.

To overcome these issues, systems and methods are described herein for decoupling asset capture from command stream capture during API tracing. This is achieved by storing assets in a shared external repository, termed an “asset vault,” that can be referenced by multiple traces. When a new trace is captured, the system checks if the assets already exist in the asset vault. If they do, the trace file includes references to the stored assets, rather than duplicating the data. When assets change or new assets are created, a separate “delta asset” file captures these updates, patching the asset vault as needed to maintain trace accuracy. This approach reduces the need to re-save unmodified assets and minimizes memory and CPU overhead.

The above approaches improve on previous methods by significantly reducing trace file sizes, memory usage, and CPU load during capture. By reusing asset data stored in the asset vault across multiple traces, the system minimizes redundancy and increases capture efficiency. Furthermore, by separating the asset capture phase from command stream capture, this method reduces performance impacts on the system, allowing for more accurate profiling and trace recording. These improvements enable developers to perform high-fidelity API tracing and debugging with lower resource demands, enhancing the usability and scalability of API tracing tools.

According to an aspect of the disclosure, a method includes the steps of generating, at an initial stage of an application session, an asset vault comprising a set of assets captured by an API recording mechanism for use by an application; initiating a capture process within the application session; recording API commands in a capture file during the capture process, wherein the capture file includes a reference to the asset vault; and generating one or more images or frames of rendered content using the capture file.

According to another aspect of the disclosure, an apparatus includes a memory configured to store an asset vault comprising a set of assets captured by an API recording mechanism for use by an application, wherein the asset vault is generated at an initial stage of an application session. The apparatus further includes a processor configured to initiate a capture process within the application session; a capture module configured to record API commands in a capture file during the capture process, wherein the capture file includes a reference to the asset vault; and a rendering module configured to generate one or more images or frames of rendered content using the capture file.

According to another aspect of the disclosure, a non-transitory computer-readable storage medium storing instructions is provided. The instructions, when executed by a processor, cause a computing device to generate, at an initial stage of an application session, an asset vault comprising a set of assets captured by an API recording mechanism for use by an application; initiate a capture process within the application session; record API commands in a capture file during the capture process, wherein the capture file includes a reference to the asset vault; and generate one or more images or frames of rendered content using the capture file.

### BRIEF DESCRIPTION OF THE DRAWING

In the following section, the aspects of the subject matter disclosed herein will be described with reference to exemplary embodiments illustrated in the figures, in which:

FIG. 1 illustrates two capture files generated by a capture service, according to an embodiment;

FIG. 2A is a block diagram illustrating an asset vault file, according to an embodiment;

FIG. 2B is a block diagram illustrating how the asset data stored in an asset vault file can replace the asset data within a capture file, according to an embodiment;

FIG. 3 is a block diagram illustrating a workflow of the asset and command capture process, according to an embodiment;

FIG. 4 illustrates the relationship between GPU memory usage and capture trace overhead during an application session, according to an embodiment;

FIG. 5 is a flowchart illustrating an API trace capture process, according to an embodiment; and

FIG. 6 is a block diagram of an electronic device in a network environment, according to an embodiment.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration. ” Any embodiment described herein as “exemplary” is not to be construed as necessarily preferred or advantageous over other embodiments. Additionally, the particular features, structures, or characteristics may be combined in any suitable manner in one or more embodiments. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.
“API” as used herein refers to a set of routines, protocols, and tools that allow an application to communicate with hardware components like a GPU. Some examples of “API” are Vulkan, DirectX, and OpenGL.
“API Trace” as used herein refers to a data file that records the commands and data sent through an API to an accelerator, allowing developers to replay the sequence of operations as they were originally executed. Some examples of “API trace” include capture files generated during debugging or performance analysis of graphics applications.
“Capture Service” as used herein refers to a software component that intercepts and records API commands, asset data, and system state information during an application's runtime. Some examples of “capture service” include tools that generate trace files and manage the asset vault and delta data for efficient data capture.
“Asset vault” as used herein refers to a centralized repository where the initial set of assets required by an application (such as textures, shaders, and models) is stored. Some examples of “asset vault” are external files that store common assets for reference by multiple capture files. The asset vault may be stored on a user device (e.g., a mobile phone) or may be stored externally and accessed remotely.
“Delta data” as used herein refers to incremental updates to assets recorded after the initial asset capture, capturing changes made to assets during the application's runtime. Some examples of “delta data” are patches to textures, modifications to models, and updates to shader parameters recorded in a trace file.
“Capture file” as used herein refers to the output file created by the capture service, containing a trace of API commands, references to the asset vault, and delta data. Some examples of “capture file” are a single monolithic file with all assets included, replayable trace files generated during a graphics session that record both command streams and asset references.
“Replay” as used herein refers to the process of using an API trace file to reproduce the application's original operations on the GPU. Some examples of “replay” are the execution of captured command streams to debug rendering issues or analyze GPU performance in a controlled environment.

Tools exist that enable graphics drivers and similar systems to capture an application's command sequences sent to a GPU. This captured data allows for deterministic replay of the application's behavior, acting as a “black-box” recorder for debugging purposes. When capturing graphics API command streams, such as those used in a Vulkan API environment by, for example, a GFXReconstruct tracing tool, a large number of assets, such as models, textures, and scene data, are typically loaded into application-allocated memory at the start of the application. For instance, in Vulkan, these assets may be created and bound to memory using command pairs like VkCreateBuffer and VkBindBufferMemory, often followed by memory write operations (e.g., memcpy).

Many command trace utilities store these assets in a preamble section at the beginning of a capture file. While this is convenient for playback, it can be inefficient during the capture process itself, as saving these assets to memory and storage can consume significant memory bandwidth and system resources.

To address these inefficiencies, this disclosure provides a system for managing asset file capture in a way that enables reuse across multiple captures. This approach increases efficiency by reducing redundant storage of unchanged assets and command streams across captures.

In one aspect of the disclosure, a routine (e.g., an algorithm) is described for reducing memory bandwidth and CPU overhead when capturing multiple traces of a single workload. Because most assets, such as shaders, models, textures, and attribute buffers, remain unchanged between captures of the same workload, they can be stored in an external repository (such as a file, vault, or database) and referenced by hash in subsequent captures if the assets are already present. This approach avoids unnecessary duplication and saves system resources.

Additionally, if assets are modified between captures, a “delta asset file” (or “delta file”) can be created to capture the changes. This delta file can patch the original assets as needed to ensure that subsequent captures remain accurate and do not rely on outdated data. By managing asset storage and modification in this way, the system maintains data integrity across captures while minimizing resource usage.

Various embodiments may be implemented by a computer system comprising a CPU, memory bus, and accelerator (such as a GPU, neural processing unit (NPU), or digital signal processor (DSP)), and may operate using an API that enables command exchange between the CPU and the accelerator. The system captures these commands through an API-interception tracing software tool.

An API capture trace may be a data file that includes the full set of data and commands required to replay the recorded session over a defined time period. This trace captures all necessary assets, including images, textures, shaders, vertices, and metadata, which are used for recreating the desired output. Typically, these assets must be loaded early in the application's lifecycle so that the commands issued later in the session can reference and utilize them.

In addition to capturing core assets, the system records control commands and updates to assets, which are saved in a database referred to as an asset file, asset vault or asset data. Modifications to assets can be stored in a delta file or as delta data, which appends updates to or patches the original asset file snapshot. This allows the trace to evolve by incorporating only incremental changes without duplicating the entire database.

The API captures may start at the beginning of the application session, with the asset file being initialized from scratch for each run. However, to minimize capture overhead, it is advantageous to create the initial asset file before the primary trace capture begins. This initial asset file can be generated manually, either by the user selecting a specific start frame or time, or automatically through predefined heuristics. For example, one heuristic might assess the rate of increase in the asset file's size, assuming that when the growth rate stabilizes, the loading process is complete. Another heuristic might monitor GPU utilization, concluding that loading is complete when GPU activity reaches a certain threshold.

Once the initial asset file is created, any additional asset data may be stored in delta asset file files as delta data, which can temporarily patch the original asset file. For compression and simplicity, these delta data files can later be placed into the main asset file, consolidating the incremental data.

During replay, API captures that occur after the creation of the asset file may use a correlation mechanism to verify that referenced assets exist within the asset file. This correlation mechanism might use metadata descriptions, asset identity structures, or binary data hashes as keys. If there is a metadata hash collision, the system can use a secondary binary data hash to differentiate assets accurately. If an asset referenced in the trace is not present in the asset file, it may be stored in a new delta asset file, which links to the original asset file and any prior delta asset files in a daisy-chain fashion.

In some cases, entirely separate runs of an application may also reference an existing asset file, provided that certain conditions are met. For instance, the application may be required to exhibit deterministic behavior regarding threading, asset creation, and storage. Additionally, there must be a mechanism in place to correlate assets across different runs efficiently, without requiring a complete binary comparison of the asset data. This approach may require prior knowledge of the application's structure to ensure accurate and efficient asset correlation.

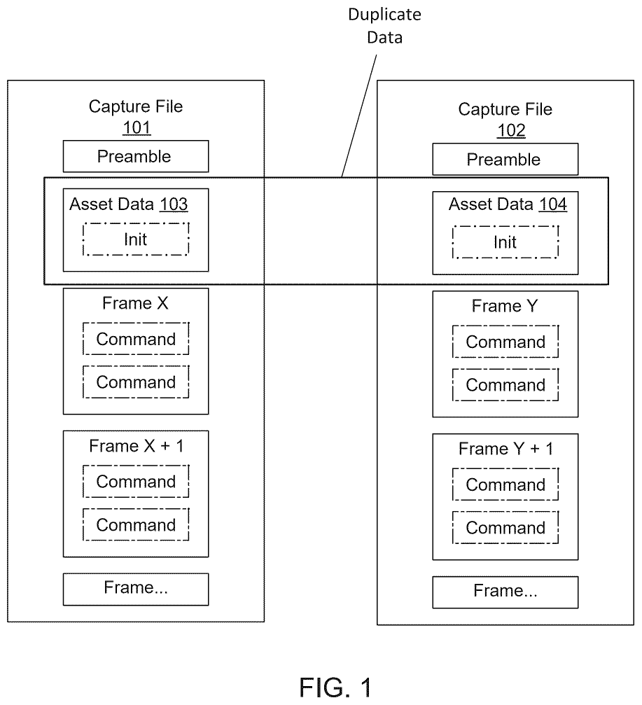

FIG. 1 illustrates two capture files generated by a capture service, according to an embodiment.

Referring to FIG. 1, individual capture files 101 and 102 are generated for each trace of an application session. Each capture file includes a preamble or file header that defines version and device information, followed by an asset data block, 103 and 104, respectively, and then a sequence of frames starting at a designated frame (e.g., frame X in the case of capture file 101, or frame Y in the case of capture file 102). If the capture begins at the first frame (X=1 or Y=1), the asset data is typically embedded directly in the command streams of the frames, eliminating the need for a separate asset data block. However, if the capture starts after the first frame (X>1 or Y>1), an asset data block 103 and an asset data block 104 is included to store the asset creation commands preceding frame X in capture file 101 or preceding frame Y in capture file 102, ensuring that all necessary assets are prepared for playback before the command sequence begins.

FIG. 1 also highlights an issue that occurs when capturing multiple traces of the same play session. Each capture file 101 and 102 records a full set of asset data in asset data blocks 103 and 104, respectively, for the application, regardless of whether those assets remain unchanged across captures. This duplication of asset data across capture files leads to significantly larger files and increased storage and processing demands, as the same assets are redundantly saved with each capture.

To address the issue of asset duplication across multiple captures, an embodiment of the disclosure provides a method for isolating these assets in a dedicated archive file, referred to as an “asset vault”, “asset file”, or “asset file vault”.

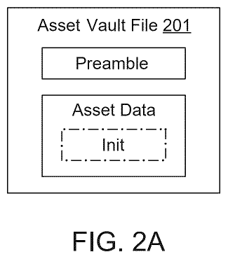

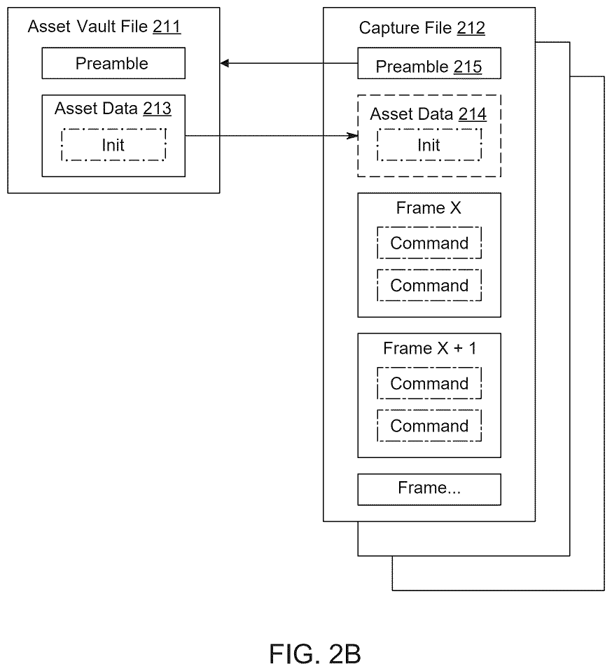

FIG. 2A is a block diagram illustrating an asset vault file, according to an embodiment.

Referring to FIG. 2A, the asset vault file includes a preamble section, which includes metadata such as version and device information. This preamble allows the asset vault file 201 to be compatible with different capture sessions by providing the necessary system and version context for the stored assets. Below the preamble, the asset vault file 201 includes an asset data block, which stores the actual assets required by the application, such as models, textures, and shaders. The “init” designation within the asset data block indicates that this data includes initial assets that do not change frequently across different captures of the same application session.

By storing assets in a central asset vault file 201, this approach enables subsequent capture files to reference the shared assets instead of duplicating them. This reduces capture file sizes and minimizes memory and CPU usage during the capture process. If an asset is already present in the asset vault file 201, it can be reused across multiple captures, thereby avoiding redundant storage and conserving system resources.

FIG. 2B is a block diagram illustrating how the asset data stored in an asset vault file can replace the asset data within a capture file, according to an embodiment.

Referring to FIG. 2B, in this approach, the asset vault file 211 acts as a centralized repository for assets, enabling multiple capture files to reference shared asset data rather than duplicating it.

In this embodiment, the asset data 213 replaces the asset data 214 that would typically be included in each capture file. As shown in FIG. 2B, the capture file 212 includes a preamble 215 including a reference to the asset vault file 211, allowing the capture file 212 to access the required assets without storing them directly. This asset vault file 211 can be created at the time the first capture file is generated, providing an initial set of assets that future captures can reference as needed. This design maintains performance comparable to traditional capture methods, as the asset data 213 generated initially and is readily accessible for replay.

During replay of a capture file, the asset vault file 211 can be loaded based on the reference found in the capture file's preamble 215, rather than retrieving assets from within the capture file 212 itself. This configuration allows subsequent capture files of the same application session to reference the same asset vault file 211, reducing redundancy and storage demands.

To handle situations where assets might change between captures, a delta data block (or file) can be included into any captures made after the initial asset vault file 211 is created.

According to an embodiment, the delta data block can ensure data integrity by recording updates to assets that may have been modified, replaced, or added after the asset vault file 211 was initially generated. During replay, the system may load the asset vault file 211 from the capture file preamble 215 and then apply the delta data to ensure that all assets are current.

The delta data block can capture various types of asset changes, including new graphics API object initializations, memory allocations, or updates to existing objects or memory. Additionally, the capture service can create the asset vault file 211 independently of the capture files, ideally at an earlier stage or frame, enabling a “cache assets” operation that allows assets to be preloaded.

In this configuration, even the first capture can be treated similarly to subsequent captures by including a delta data block, allowing the asset vault to be decoupled from the main command stream data collection. This separation of asset storage from command stream data improves efficiency and addresses the issue of redundant asset storage across multiple captures.

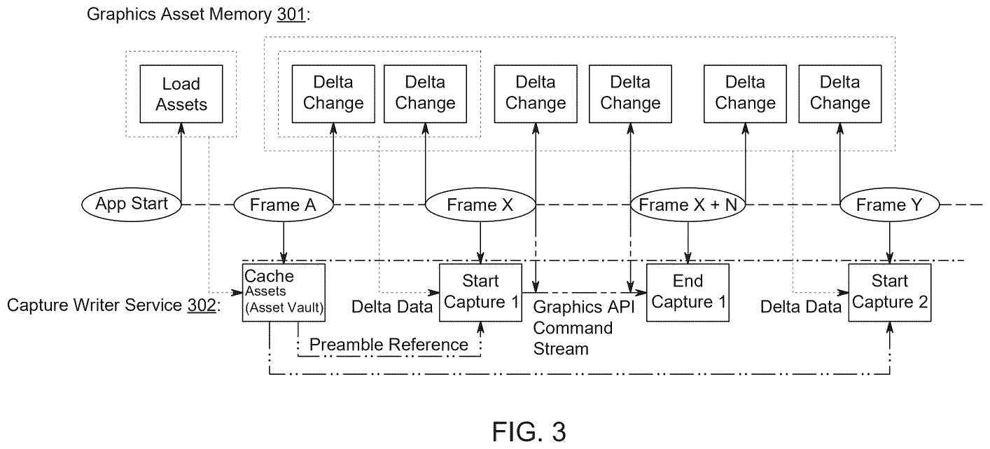

FIG. 3 is a block diagram illustrating a workflow of the asset and command capture process, according to an embodiment.

Referring to FIG. 3, the graphics asset memory 301 timeline begins with the application start, where the application initializes and loads necessary asset data, such as textures, shaders, and models, into memory in preparation for rendering. This initial load includes all the core resources the application will require throughout execution. As the application runs, some assets in memory may be modified, leading to delta changes between frames. These delta changes represent updates to the asset data that the system records for potential use in later captures.

The capture writer service 302 timeline at the bottom of FIG. 3 shows how the capture process is managed. At an early stage, designated as frame A, the capture service performs a cache assets operation. During this operation, the capture service preemptively saves the initial set of assets into a separate file called the asset vault, which acts as a centralized repository for all core assets needed by the application. This step ensures that the asset vault contains the complete state of the graphics assets before detailed frame capture begins, thereby reducing the system load during the capture process itself. Once created, the asset vault can be referenced by multiple capture files, minimizing redundancy and allowing these files to share common data without re-saving it.

The first capture session, shown starting at frame X, begins by recording a preamble reference in the capture file, which points to the pre-existing asset vault created at frame A. This reference enables the capture file to rely on the centralized asset vault for asset data rather than duplicating all assets within the file itself. During the first capture session, which continues from frame X to frame X+N, the capture service records the graphics API command stream. This stream includes the sequence of rendering commands that the application sends to the GPU to generate each frame. The capture service also records any delta data between frame A and frame X, which captures asset modifications made after the initial asset caching. This delta data ensures that any asset updates that occurred since the initial asset capture are accurately reflected.

As the application continues to run, additional delta changes to the assets may accumulate in memory as the application modifies its data. At a later point, designated as frame Y, a second capture session begins. Like the first session, this second capture references the original asset vault created at frame A by including a preamble reference that points back to it. This approach enables the second capture to reuse the same core assets without duplicating them in the file, thereby reducing file size and system overhead. Before starting the second capture, the capture service records any new delta data, which captures the asset modifications that occurred between the end of the first capture session and frame Y. This new delta data block is stored within the capture file for the second session, ensuring that all relevant asset updates are preserved and correctly applied during replay.

Accordingly, in this method, the asset vault serves as a shared repository for all initial assets, reducing the need to duplicate data across capture files. Each capture session includes delta data blocks that contain only the incremental changes to assets, maintaining up-to-date asset information while minimizing storage requirements. Each capture file also contains a preamble reference that links back to the asset vault, establishing a consistent reference point for asset data and further reducing the need for duplicate storage.

This process enhances efficiency by separating the storage of static asset data from the dynamic command stream, allowing developers to perform multiple capture sessions without redundant asset data. By centralizing the initial assets and tracking only incremental changes, this method reduces capture file sizes, lowers system overhead, and provides accurate, high-performance traces for debugging and profiling across multiple sessions.

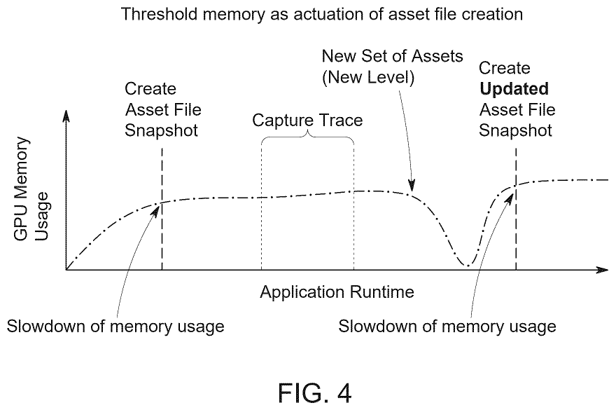

FIG. 4 illustrates the relationship between GPU memory usage and capture trace overhead during an application session, according to an embodiment. More specifically, FIG. 4 demonstrates how memory usage and overhead fluctuate based on asset loading, asset unloading, and the activation of capture events.

Referring to FIG. 4, at the start of the session, as the application initializes, GPU memory usage rises steeply as initial assets (such as textures, models, and shaders) are loaded. This initial load corresponds to an upward trend in the memory usage line, indicating increasing memory usage until it reaches a steady state. At this point, the application has loaded most of its required assets, and GPU memory usage levels off.

The capture trace overhead, represented by the memory usage line, shows a high initial memory usage. This high memory usage occurs due to the intense memory and CPU activity required to capture all initial assets and data from the GPU when the first capture begins. This overhead includes the cost of transferring asset data to storage and organizing it within the capture file.

As the application runs, capture trace overhead may drop after the initial spike, but it can increase again during specific capture events, such as gameplay, where new assets or updates may be loaded and captured. In each of these events, only incremental changes, or delta data, are captured, keeping the overhead relatively low.

At certain points, indicated by a drop in the memory usage line, the application unloads assets, such as when switching to a different level or scene. This drop in memory usage reduces the demand on the GPU's memory resources. The capture trace overhead remains stable during these intervals, as it only needs to record the current application state without reloading large asset files.

Near the end of the session, the application loads additional assets, which increases GPU memory usage and capture trace overhead.

By centralizing initial assets in the asset vault and capturing only incremental updates, the system reduces the memory and overhead burden, allowing developers to perform captures efficiently even in memory-intensive applications.

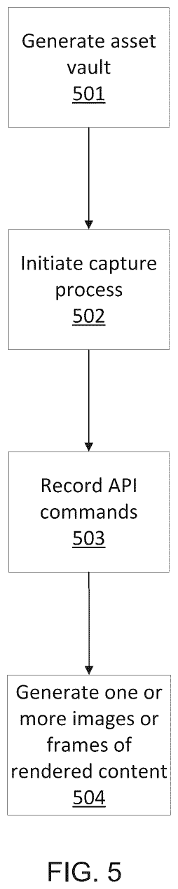

FIG. 5 is a flowchart illustrating an API trace capture process, according to an embodiment.

The steps illustrated in FIG. 5 may be performed by a capture service operating within a computing device, such as a computer or an electronic device equipped with a GPU.

Referring to FIG. 5, in step 501, an asset vault is generated. The asset vault may be generated at an initial stage of an application session. The asset vault may include a set of assets captured by an API recording mechanism for use by an application, such as textures, shaders, models, and metadata.

In step 502, a capture process is initiated. The capture process may be initiated within the application session, which may be specified manually by a user, automatically based on predefined criteria, or semi-automatically based on a combination thereof.

In step 503, API commands are recorded. The API commands may be recorded in a capture file during the capture process. The capture file may include a reference to the asset vault, allowing it to access assets stored in the vault. Additionally, any modifications to assets that occur during the capture process may be detected and stored as delta data in a separate file.

In step 504, one or more images or frames of rendered content are generated. The one or more images or frames may be generated using the capture file, which may include API commands and references to the asset vault.

Accordingly, in accordance with an embodiment, optimizing asset-database per capture/sub-capture can be accomplished by tracking the use of each asset during a replay and removing assets that are not accessed.

In addition, in accordance with an embodiment, comparing multiple asset databases from multiple captures can help generate a more robust and smaller asset-database by removing any assets that are not identical from run to run. This can also improve trace file size and portability. Additionally, in accordance with an embodiment, capture files (e.g., a single monolithic file with all assets included) may be regenerated from an asset database that can improve trace portability and allow the trace to be played back without any additional files.

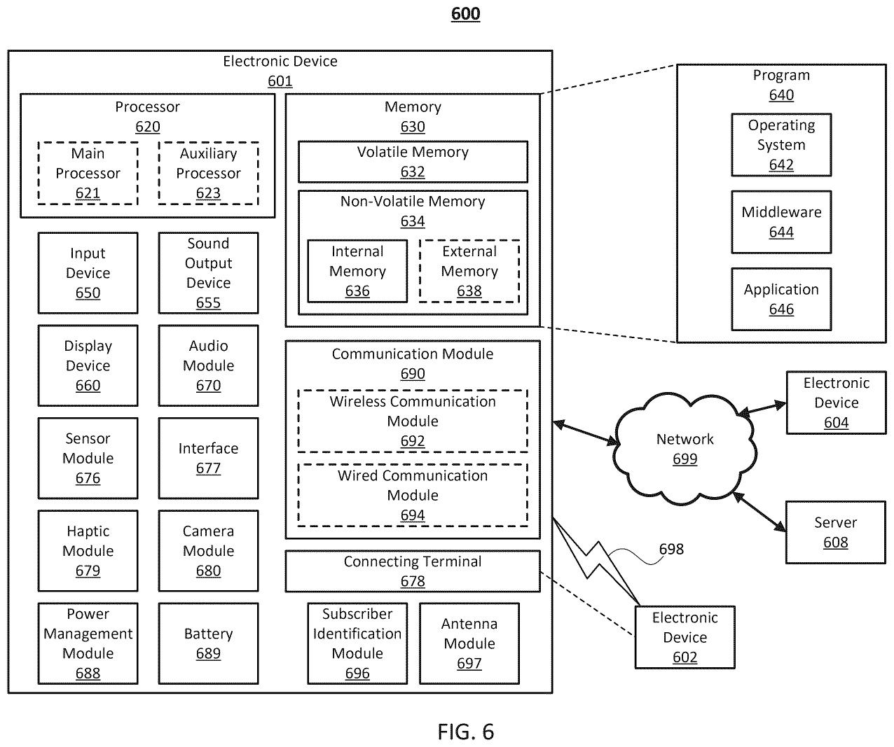

FIG. 6 is a block diagram of an electronic device in a network environment, according to an embodiment.

Referring to FIG. 6, an electronic device 601 in a network environment 600 may communicate with an electronic device 602 via a first network 698 (e.g., a short-range wireless communication network), or an electronic device 604 or a server 608 via a second network 699 (e.g., a long-range wireless communication network). The electronic device 601 may communicate with the electronic device 604 via the server 608. The electronic device 601 may include a processor 620, a memory 630, an input device 650, a sound output device 655, a display device 660, an audio module 670, a sensor module 676, an interface 677, a haptic module 679, a camera module 680, a power management module 688, a battery 689, a communication module 690, a subscriber identification module (SIM) card 696, or an antenna module 697. In one embodiment, at least one (e.g., the display device 660 or the camera module 680) of the components may be omitted from the electronic device 601, or one or more other components may be added to the electronic device 601. Some of the components may be implemented as a single integrated circuit (IC). For example, the sensor module 676 (e.g., a fingerprint sensor, an iris sensor, or an illuminance sensor) may be embedded in the display device 660 (e.g., a display).

The electronic device 601 in a network environment 600, may execute methods for capturing and replaying API traces, specifically for commands sent to an accelerator like a GPU. The processor 620 may provide commands to perform the capture process, managing both the initial asset data stored in an asset vault and any delta data recorded during an application's runtime. The processor 620 may also coordinate the replay process, using the data in the capture file to issue commands to the GPU or other accelerators, reproducing the application's original graphics output.

Memory 630 may store both the asset vault and the delta data files. By offloading large, redundant asset data from each capture file into a shared asset vault, the solutions proposed herein reduce the memory and storage requirements for multiple capture sessions, freeing up memory resources for other tasks within the device. The memory 630 is further utilized to store metadata, asset hashes, and other correlation data, allowing efficient reference and retrieval of assets during replay.

The communication module 690 may enable the device to transfer capture files, asset vaults, or delta data between devices, such as to a server 608 for debugging or analysis in a remote environment. This feature allows developers to capture traces on one device and replay them on another, facilitating cross-device testing and debugging. Additionally, if the device 601 has a GPU, NPU, or DSP, these accelerators can directly benefit from the optimized capture process, as reduced trace overhead allows more efficient utilization of these specialized processors for graphics and artificial intelligence (AI) tasks.

The processor 620 may execute software (e.g., a program 640) to control at least one other component (e.g., a hardware or a software component) of the electronic device 601 coupled with the processor 620 and may perform various data processing or computations.

As at least part of the data processing or computations, the processor 620 may load a command or data received from another component (e.g., the sensor module 676 or the communication module 690) in volatile memory 632, process the command or the data stored in the volatile memory 632, and store resulting data in non-volatile memory 634. The processor 620 may include a main processor 621 (e.g., a CPU or an application processor (AP)), and an auxiliary processor 623 (e.g., a GPU, an image signal processor (ISP), a sensor hub processor, or a communication processor (CP)) that is operable independently from, or in conjunction with, the main processor 621. Additionally or alternatively, the auxiliary processor 623 may be adapted to consume less power than the main processor 621, or execute a particular function. The auxiliary processor 623 may be implemented as being separate from, or a part of, the main processor 621.

The auxiliary processor 623 may control at least some of the functions or states related to at least one component (e.g., the display device 660, the sensor module 676, or the communication module 690) among the components of the electronic device 601, instead of the main processor 621 while the main processor 621 is in an inactive (e.g., sleep) state, or together with the main processor 621 while the main processor 621 is in an active state (e.g., executing an application). The auxiliary processor 623 (e.g., an image signal processor or a communication processor) may be implemented as part of another component (e.g., the camera module 680 or the communication module 690) functionally related to the auxiliary processor 623.

The memory 630 may store various data used by at least one component (e.g., the processor 620 or the sensor module 676) of the electronic device 601. The various data may include, for example, software (e.g., the program 640) and input data or output data for a command related thereto. The memory 630 may include the volatile memory 632 or the non-volatile memory 634. Non-volatile memory 634 may include internal memory 636 and/or external memory 638.

The program 640 may be stored in the memory 630 as software, and may include, for example, an operating system (OS) 642, middleware 644, or an application 646.

The input device 650 may receive a command or data to be used by another component (e.g., the processor 620) of the electronic device 601, from the outside (e.g., a user) of the electronic device 601. The input device 650 may include, for example, a microphone, a mouse, or a keyboard.

The sound output device 655 may output sound signals to the outside of the electronic device 601. The sound output device 655 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 660 may visually provide information to the outside (e.g., a user) of the electronic device 601. The display device 660 may include, for example, a display, a hologram device, or a projector and control circuitry to control a corresponding one of the display, hologram device, and projector. The display device 660 may include touch circuitry adapted to detect a touch, or sensor circuitry (e.g., a pressure sensor) adapted to measure the intensity of force incurred by the touch.

The audio module 670 may convert a sound into an electrical signal and vice versa. The audio module 670 may obtain the sound via the input device 650 or output the sound via the sound output device 655 or a headphone of an external electronic device 602 directly (e.g., wired) or wirelessly coupled with the electronic device 601.

The sensor module 676 may detect an operational state (e.g., power or temperature) of the electronic device 601 or an environmental state (e.g., a state of a user) external to the electronic device 601, and then generate an electrical signal or data value corresponding to the detected state. The sensor module 676 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 677 may support one or more specified protocols to be used for the electronic device 601 to be coupled with the external electronic device 602 directly (e.g., wired) or wirelessly. The interface 677 may include, for example, a high-definition multimedia interface (HDMI), a universal serial bus (USB) interface, a secure digital (SD) card interface, or an audio interface.

A connecting terminal 678 may include a connector via which the electronic device 601 may be physically connected with the external electronic device 602. The connecting terminal 678 may include, for example, an HDMI connector, a USB connector, an SD card connector, or an audio connector (e.g., a headphone connector).

The haptic module 679 may convert an electrical signal into a mechanical stimulus (e.g., a vibration or a movement) or an electrical stimulus which may be recognized by a user via tactile sensation or kinesthetic sensation. The haptic module 679 may include, for example, a motor, a piezoelectric element, or an electrical stimulator.

The camera module 680 may capture a still image or moving images. The camera module 680 may include one or more lenses, image sensors, image signal processors, or flashes. The power management module 688 may manage power supplied to the electronic device 601. The power management module 688 may be implemented as at least part of, for example, a power management integrated circuit (PMIC).

The battery 689 may supply power to at least one component of the electronic device 601. The battery 689 may include, for example, a primary cell which is not rechargeable, a secondary cell which is rechargeable, or a fuel cell.

The communication module 690 may support establishing a direct (e.g., wired) communication channel or a wireless communication channel between the electronic device 601 and the external electronic device (e.g., the electronic device 602, the electronic device 604, or the server 608) and performing communication via the established communication channel. The communication module 690 may include one or more communication processors that are operable independently from the processor 620 (e.g., the AP) and supports a direct (e.g., wired) communication or a wireless communication. The communication module 690 may include a wireless communication module 692 (e.g., a cellular communication module, a short-range wireless communication module, or a global navigation satellite system (GNSS) communication module) or a wired communication module 694 (e.g., a local area network (LAN) communication module or a power line communication (PLC) module). A corresponding one of these communication modules may communicate with the external electronic device via the first network 698 (e.g., a short-range communication network, such as BLUETOOTH™, wireless-fidelity (Wi-Fi) direct, or a standard of the Infrared Data Association (IrDA)) or the second network 699 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 692 may identify and authenticate the electronic device 601 in a communication network, such as the first network 698 or the second network 699, using subscriber information (e.g., international mobile subscriber identity (IMSI)) stored in the subscriber identification module 696.

The antenna module 697 may transmit or receive a signal or power to or from the outside (e.g., the external electronic device) of the electronic device 601. The antenna module 697 may include one or more antennas, and, therefrom, at least one antenna appropriate for a communication scheme used in the communication network, such as the first network 698 or the second network 699, may be selected, for example, by the communication module 690 (e.g., the wireless communication module 692). The signal or the power may then be transmitted or received between the communication module 690 and the external electronic device via the selected at least one antenna.

Commands or data may be transmitted or received between the electronic device 601 and the external electronic device 604 via the server 608 coupled with the second network 699. Each of the electronic devices 602 and 604 may be a device of a same type as, or a different type, from the electronic device 601. All or some of operations to be executed at the electronic device 601 may be executed at one or more of the external electronic devices 602, 604, or 608. For example, if the electronic device 601 should perform a function or a service automatically, or in response to a request from a user or another device, the electronic device 601, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 601. The electronic device 601 may provide the outcome, with or without further processing of the outcome, as at least part of a reply to the request. To that end, a cloud computing, distributed computing, or client-server computing technology may be used, for example.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Additionally or alternatively, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method comprising:
generating, at an initial stage of an application session, an asset vault comprising a set of assets captured by an application programming interface (API) recording mechanism for use by an application;
initiating a capture process within the application session;
recording API commands in a capture file during the capture process, wherein the capture file includes a reference to the asset vault; and
generating one or more images or frames of rendered content using the capture file.

2. The method of claim 1, further comprising:
detecting modifications to the assets during the capture process; and
storing the modifications in a delta data file separate from the asset vault.

3. The method of claim 2, further comprising replaying the capture file by referencing the asset vault and applying the delta data file to reproduce the captured assets expected for correct output rendering.

4. The method of claim 2, wherein storing modifications in the delta data file comprises detecting new or modified graphics API objects and recording them in the delta data file.

5. The method of claim 2, further comprising creating additional delta data files for subsequent captures of the application session, wherein each delta data file references the asset vault to avoid duplicating unchanged assets.

6. The method of claim 1, wherein generating the asset vault further comprises generating a first asset vault comprised of a first set of the assets and generating a second asset vault comprised of a second set of the assets.

7. The method of claim 1, further comprising verifying that referenced assets in the capture file exist within the asset vault.

8. An apparatus comprising:
a memory configured to store an asset vault comprising a set of assets captured by an application programming interface (API) recording mechanism for use by an application, wherein the asset vault is generated at an initial stage of an application session;
a processor configured to initiate a capture process within the application session;
a capture module configured to record API commands in a capture file during the capture process, wherein the capture file includes a reference to the asset vault; and
a rendering module configured to generate one or more images or frames of rendered content using the capture file.

9. The apparatus of claim 8, further comprising:
an asset detection module configured to detect modifications to the assets during the capture process; and
a delta data module configured to store the modifications in a delta data file separate from the asset vault.

10. The apparatus of claim 9, further comprising:
a replay module configured to replay the capture file by referencing the asset vault and applying the delta data file to reproduce the captured assets expected for correct output rendering.

11. The apparatus of claim 9, wherein the delta data module is further configured to detect new or modified graphics API objects and record them in the delta data file.

12. The apparatus of claim 9, further comprising:
a delta data module configured to create additional delta data files for subsequent captures of the application session, wherein each delta data file references the asset vault to avoid duplicating unchanged assets.

13. The apparatus of claim 8, wherein generating the asset vault further comprises generating a first asset vault comprised of a first set of the assets and generating a second asset vault comprised of a second set of the assets.

14. The apparatus of claim 8, further comprising:
a correlation module configured to verify that referenced assets in the capture file exist within the asset vault.

15. A non-transitory computer-readable storage medium storing instructions that, when executed by a processor, cause a computing device to:
generate, at an initial stage of an application session, an asset vault comprising a set of assets captured by an application programming interface (API) recording mechanism for use by an application;
initiate a capture process within the application session;
record API commands in a capture file during the capture process, wherein the capture file includes a reference to the asset vault; and
generate one or more images or frames of rendered content using the capture file.

16. The non-transitory computer-readable storage medium of claim 15, wherein the instructions, when executed by the processor, further cause the computing device to:
detect modifications to the assets during the capture process; and
store the modifications in a delta data file separate from the asset vault.

17. The non-transitory computer-readable storage medium of claim 16, wherein the instructions, when executed by the processor, further cause the computing device to replay the capture file by referencing the asset vault and applying the delta data file to reproduce the captured assets expected for correct output rendering.

18. The non-transitory computer-readable storage medium of claim 16, wherein the instructions, when executed by the processor, further cause the computing device to store modifications in the delta data file by detecting new or modified graphics API objects and recording them in the delta data file.

19. The non-transitory computer-readable storage medium of claim 16, wherein the instructions, when executed by the processor, further cause the computing device to create additional delta data files for subsequent captures of the application session, wherein each delta data file references the asset vault to avoid duplicating unchanged assets.

20. The non-transitory computer-readable storage medium of claim 15, wherein generating the asset vault further comprises generating a first asset vault comprised of a first set of the assets and generating a second asset vault comprised of a second set of the assets.
